(19) United States
(12) Patent Application Publication
(10) Pub. No.: US 2007/0229480 A1
(43) Pub. Date: Oct. 4, 2007

(54) Picture display device and picture display method

(75) Inventor: Yasuhiro Ookawara, Tokyo (JP)

Correspondence Address: BLAKELY SOKOLOFF TAYLOR & ZAFMAN, 1279 OAKMEAD PARKWAY, SUNNYVALE, CA, 94085-4040, US

(73) Assignee: Kabushiki Kaisha Toshiba

(21) Appl. No.: 11/595,605

(22) Filed: Nov. 9, 2006

(30) Foreign Application Priority Data
Mar. 31, 2006 (JP) P2006-097560

(51) Int. Cl. G09G 5/00

(52) U.S. Cl. 345/204

(57) ABSTRACT

A picture display device 1 for displaying a picture based on a picture signal includes: a correction data storage means 13 for storing compressed data of correction data for correcting luminance variations among display pixels, compressed by a predetermined data compression technique; a picture signal correction means 15 for correcting the picture signal based on the compressed data stored in the correction data storage means to generate a picture signal in which the luminance variations among the display pixels are corrected; and a picture display means 18 for displaying a picture based on the picture signal in which the luminance variations among the display pixels are corrected.

### BACKGROUND

1. Field of the Invention

Embodiments of the present invention relates to a picture display device and a picture display method each for correcting luminance variations for each pixel generated in a display.

2. Related Background Art

In a picture display device, to correct unevenness of luminance and unevenness of color caused by variations in luminance characteristics among light emitting elements, the following is performed, that is, correction data for correcting the variations in luminance characteristics for each display pixel is previously stored in a memory, and a picture signal is corrected based on the correction data. A picture display device for performing correction of a picture signal as described above is disclosed in Patent Document 1 (Japanese Patent Application Laid-open No. 2004-157309).

In the picture display device according to Patent Document 1, correction data for each of display pixels of a display is stored in a memory. Upon taking in a picture signal for a predetermined display pixel, the picture display device corrects the picture signal using the correction data for that display pixel. The size of the correction data for each display pixel is set to the number of bits (4 bits, 6 bits or the like) smaller than that of the picture signal (10 bits), whereby the capacity of the memory for storing the correction data is reduced to suppress the product cost. To further suppress the product cost, however, it is necessary to further reduce the capacity of the memory for storing the correction data.

As described above, there is a demand for further reduction in the capacity of the memory for storing the correction data for correcting the variations in luminance characteristics for each display pixel in the picture display device.

### BRIEF DESCRIPTION OF THE DRAWINGS

The invention may best be understood by referring to the following description and accompanying drawings that are used to illustrate embodiments of the invention.

FIG. 1 is a block diagram of a picture display device according to an embodiment of the present invention;

FIG. 2 is an exemplary diagram for explaining correction data before compression;

FIG. 3 is an exemplary diagram for illustrating a second modification example of the correction data stored in a correction value memory;

FIG. 4 is an exemplary diagram for illustrating a third modification example of the correction data stored in the correction value memory;

FIG. 5 is an exemplary diagram for illustrating a fourth modification example of the correction data stored in the correction value memory; and

FIG. 6 is an exemplary diagram for illustrating a fifth modification example of the correction data stored in the correction value memory.

### DETAILED DESCRIPTION

Hereinafter, various embodiments relating to a picture display device of the present invention will be described with reference to the drawings.

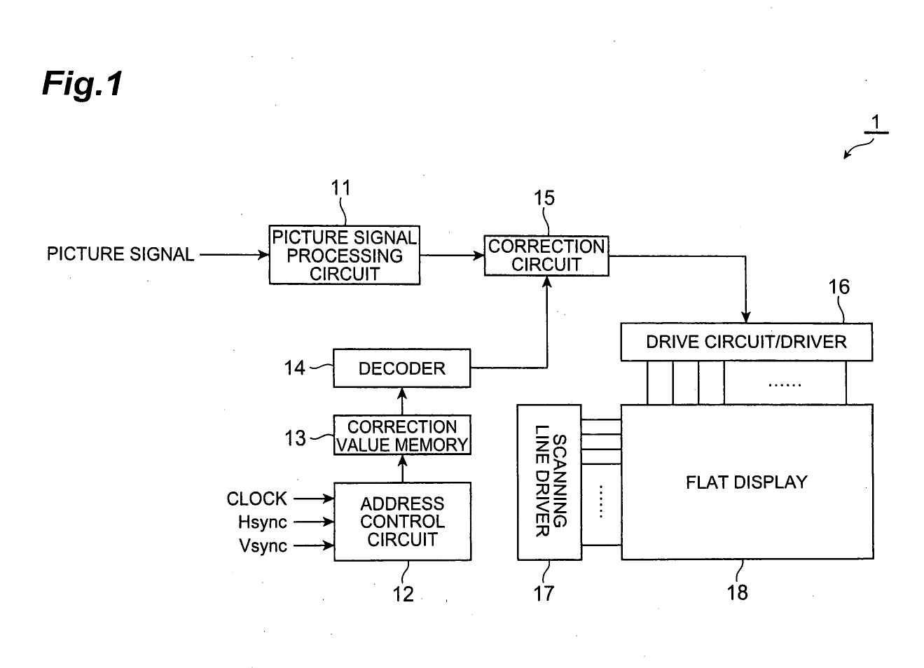

FIG. 1 shows an exemplary block diagram of a picture display device 1. The picture display device 1 includes a picture signal processing circuit 11, an address control circuit 12, a correction value memory 13, a decoder 14, a correction circuit 15, a drive circuit (driver) 16, a scanning line driver 17, and a display 18. Although not shown, it is contemplated that the picture display device 1 may be in communication with a Y receiving device (tuner).

The picture signal processing circuit 11 sequentially takes in signals received by the receiving device and performs predetermined picture signal processing on the broadcast signals. More specifically, the picture signal processing circuit 11 may be adapted to convert incoming (broadcast) signals into picture signals in the form of digital RGB signals (digital RGB picture signals) and outputs the digital RGB picture signals to the correction circuit 15.

Into the address control circuit 12, a clock signal (Clock), a horizontal synchronization signal (Hsync), and a vertical synchronization signal (Vsync) are inputted. These signals may be generated in the picture display device 1. The Clock signal, the Hsync signal, and the Vsync signal specify the position of a display pixel to which the digital RGB picture signal outputted from the picture signal processing circuit 11 to the correction circuit 15 corresponds.

Upon taking in the Clock signal, the Hsync signal, and the Vsync signal, the address control circuit 12 outputs, to the correction value memory 13, a signal for reading correction data for the pixel position specified by these signals.

The correction value memory 13 is a correction data storage means that stores correction data for correcting unevenness of luminance and unevenness of color caused by variations in luminance characteristics among display pixels, in the state compressed by a predetermined data compression technique. The correction value memory 13 is composed of a non-volatile memory. The above-described correction data is obtained by measuring in advance the variations in luminance characteristics among the display pixels of the flat display 18.

Various techniques can be employed as the technique of compressing the correction data. For example, those techniques may include, but are not limited to (i) techniques of reversibly compressing data such as run-length coding, Huffman coding, Lempel-Ziv coding, and arithmetic coding; (ii) a technique of nonreversibly compressing data such as coding by JPEG (Joint Photographic Coding Experts Group) format, or (iii) techniques made by combining the plurality of these compression techniques. These data compression techniques are techniques of compressing correction data by coding the correction data according to predetermined rules.

To describe the compressed data stored in the correction value memory 13 in detail, the original correction data before compression and the correction data after compression will be described in comparison with each other. In the following description, it is assumed that the position of the display pixel in the horizontal direction is i (=1, 2, 3, 4, . . . ) and the position of the display pixel in the vertical direction is j (=0, 1, 2, 3, . . . ). Accordingly, the position of display pixel within a display surface of the flat display 18 is represented by ‘ji.’ It is assumed that a red light emitting element is Rji, a green light emitting element is Gji, and a blue light emitting element is Bji in this display pixel.

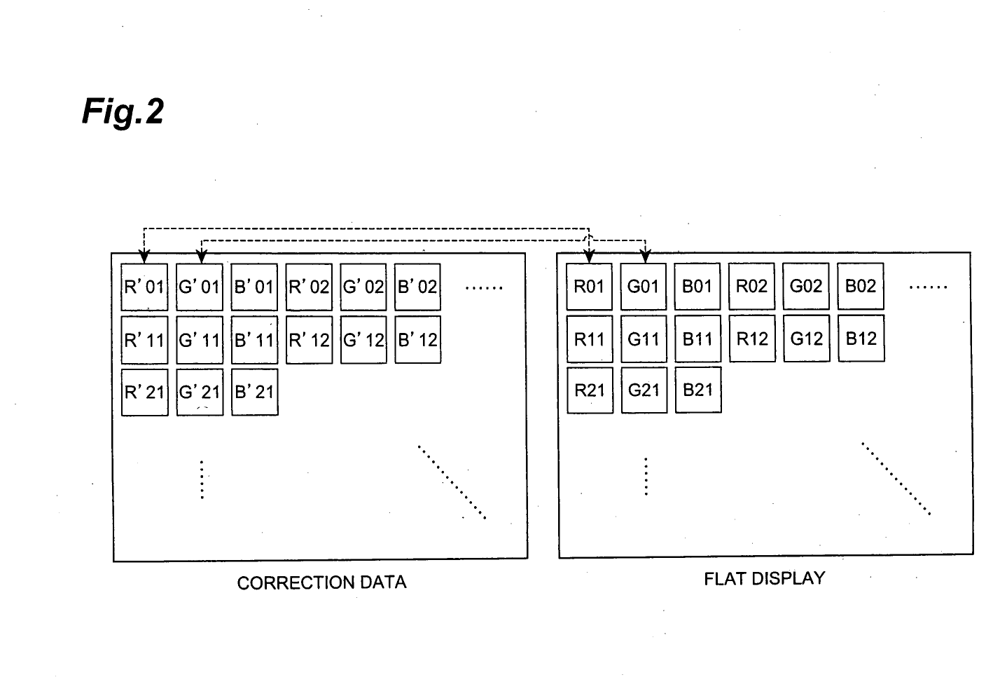

FIG. 2 shows the correspondence between the original correction data R′ji, G′ji, and B′ji before compression and the display pixels Rji, Gji, Bji constituting the flat display 18. The original correction data R′ji, G′ji, and B′ji before compression are prepared for display colors of the light emitting elements for each of the display pixels Rji, Gji, Bji constituting the flat display 18, respectively. More specifically, one piece of correction data R′ji is prepared for each red light emitting element Rji, one piece of correction data G′ji is prepared for each green light emitting element Gji, and one piece of correction data B′ji is prepared for each blue light emitting element Bji.

On the other hand, the compressed data to be stored in the correction value memory 13 is generated by compressing the original correction data using the aforementioned various compression techniques. In the case where the correction data is compressed using the technique such as the run-length coding, Huffman coding, Lempel-Ziv coding, or arithmetic coding, the correction data is separated for each of the display colors of the light emitting elements and then code the correction data according to the order of the display pixels scanned at the time of displaying an image. Besides, where the correction data is compressed using the technique such as the coding by JPEG format, the correction data should be separated for each of the display colors of the light emitting elements and further separate the correction data for each of the fixed blocks made up of 8 pixels by 8 pixels and then code the correction data for each of the blocks.

In this embodiment of the invention, since the correction data for correcting the variations in luminance characteristics among the display pixels is stored in the compressed state as described above, the storage capacity of the correction value memory 13 can be reduced. In particular, since the correction data is separated for each of the display colors (R, G, and B) of the light emitting elements, and the correction data is then compressed for each of the display colors, the storage capacity of the correction value memory 13 can be further reduced. In other words, when the correction data is separated for each of the display colors, the values of the separated correction data do not tend to significantly vary between adjacent display pixels, and therefore the correction data can be efficiently compressed.

Upon taking in the signal outputted from the address control circuit 12, the correction value memory 13 outputs, to the decoder 14, minimum compressed data needed for restoring the correction data for the display pixel specified by the Clock signal, the Hsync signal, and the Vsync ¥ signal. More specifically, the correction value memory 13 outputs only a portion of the compressed data required for restoring the correction data for the above-described specific display pixel from the compressed data stored in the correction value memory 13. For example, where the correction data is compressed by the technique such as the run-length coding, Huffman coding, Lempel-Ziv coding, or arithmetic coding, the compressed data of the correction data for the display pixel specified as described above are outputted. Besides, where the correction data is compressed by the technique such as the coding by JPEG format, the compressed data for the fixed block containing the display pixel specified as described above is outputted. Note that, as understood from the above description, the signal outputted from the address control circuit 12 to the correction value memory 13 is a signal for designating a storage address of a portion of the compressed data required for restoring the correction data of the specific display pixel.

The decoder 14 is a decode means for, upon taking in the compressed data outputted from the correction value memory 13, performing processing to restore the original correction data from the compressed data. As a result of the processing to restore the correction data by the decoder 14, the correction data of the display pixel are obtained which are specified by the Clock signal, the Hsync signal, and the Vsync signal. The decoder 14 restores the original correction data and then outputs the correction data to the correction circuit 15. Note that a non-volatile memory for temporarily storing the compressed data from the correction value memory 13 and the correction data after restoration is prepared in the decoder 14, but the capacity of this non-volatile memory is small.

The correction circuit 15 is a picture signal correction means for performing calculation processing to correct the digital picture signal from the picture signal processing circuit 11 based on the correction data from the decoder 14. In other words, the correction circuit 15 multiplies the digital picture signal by the correction data to thereby adjust the gradation of the digital picture signal. Such processing of the correction circuit 15 generates a digital picture signal in which the variations in luminance characteristics among the display pixels are corrected within the flat display 18. The correction circuit 15 outputs, to the drive circuit 16, the digital picture signal in which the variations in luminance characteristics among the display pixels are corrected.

The drive circuit (driver) 16 takes in the digital picture signal in which the variations in luminance characteristics among the display pixels are corrected, and supplies a driving voltage for performing gradation display on the flat display 18. Further, the scanning line driver 17 performs turn-on operation for lines in sequence from the upper portion of the screen on a basis of one line during one horizontal scanning period. The operations of the drive circuit 16 and the scanning driver 17 cause the display pixels of the flat display 18 to emit light, whereby a picture in which the variations in luminance characteristics among the display pixels are corrected is displayed on the flat display 18. In other words, the flat display 18 is a picture display means for displaying a picture in which the variations in luminance characteristics among the display pixels are corrected. Note that examples of the flat display 18 include, for example, a Field Emission Display (FED) such as a Surface-conduction Electron-emitter Display (SED), an Electroluminescence Display (ELD), a Liquid Crystal Display (LCD), and a plasma display.

Next, a first modification example of the technique of compressing the correction data will be described. In the above-described embodiment, the correction data R′ji, G′ji, and B′ji themselves are compressed by the previously mentioned various kinds of compression techniques in order to obtain the compressed data to be stored in the correction value memory 13. In contrast to this, in the compression technique according to this modification example, after the difference in the correction data between the display pixels adjacent in the scanning direction at the time of image display is calculated, the difference in the correction data is compressed by the previously mentioned various kinds of compression techniques. More specifically, correction data differences ΔR′ji, ΔG′ji, and ΔB′ji for respective display colors are calculated by subtracting, from the correction data of a predetermined display pixel, the correction data of the display pixel adjacent on the left side of that display pixel as shown in the following mathematical expression (1), and the correction data differences ΔR′ji, ΔG′ji, and ΔB′ji are compressed. According to the technique of compressing the correction data according to the above-described modification example, the correction data differences between the adjacent display pixels are small values, so that the compression data to be stored in the correction value memory 13 can be made small, and the capacity of the correction value memory 13 can be made much smaller. Note that when the correction data is compressed as described above, the decoder 14 restores the correction data by successively adding the correction data differences.

ΔR′ji=R′ji−R′ji−1

ΔG′ji=G′ji−G′ji−1

ΔB′ji=B′ji−B′ji−1 (1)

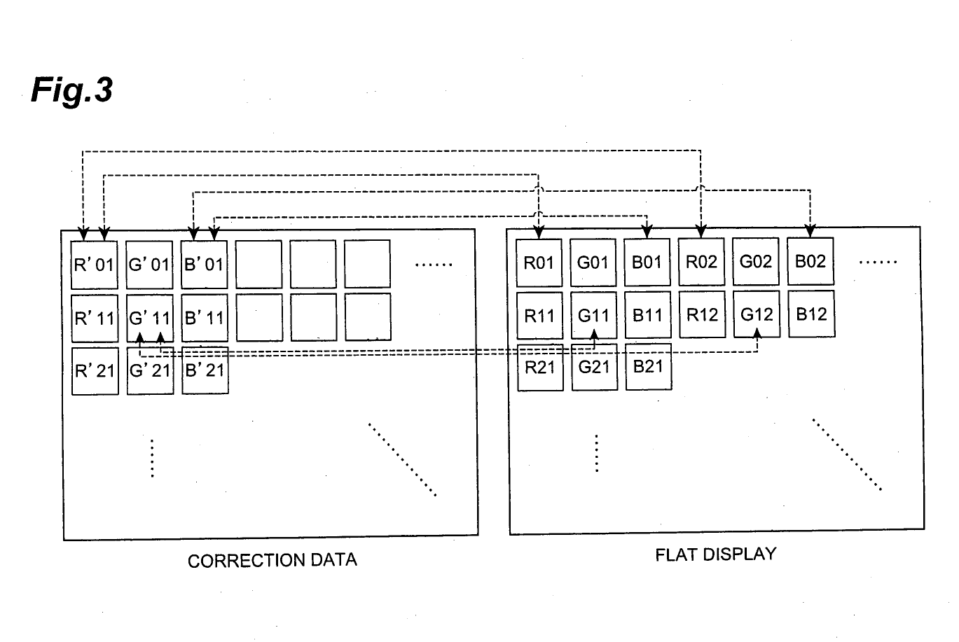

Next, a second modification example to a fifth modification example of the technique of compressing the correction data will be described with reference to FIG. 3 to FIG. 6. In each of the compression techniques shown in FIG. 3 to FIG. 5, one piece of correction data is prepared for each of the display colors of the light emitting elements as the correction data for two display pixels adjacent to each other in the display 18. Note that the compression techniques described below are of one type of the nonreversible compression in which the correction data cannot be completely restored.

In the compression technique according to the second modification example shown in FIG. 3, only correction data for one of the two display pixels is stored in the correction value memory 13 as the correction data for the two display pixels adjacent to each other in the horizontal direction in the flat display 18, and no correction data is stored in the correction value memory 13 for the other display pixel. In other words, the correction data R′ji, G′ji, and B′ji for a display pixel having an odd-numbered pixel position i in the horizontal direction are prepared as the correction data corresponding to two display pixels at the pixel positions ji and ji+1. Only one piece of correction data is used for the two display pixels as described above, whereby the storage capacity of the correction value memory 13 can be reduced to about half that of the conventional one.

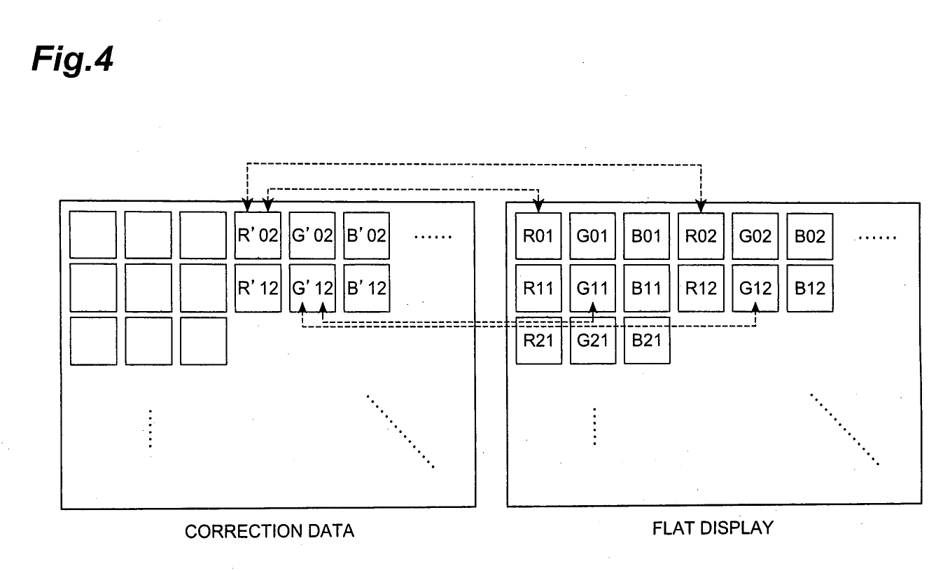

The compression technique according to the third modification example shown in FIG. 4 is similar to the above-described compression technique in FIG. 3. The correction data R′ji, G′ji, and B′ji for a display pixel having an even-numbered pixel position i in the horizontal direction are prepared as the correction data corresponding to two display pixels at the pixel positions ji−1 and ji. Also in the compression technique shown in FIG. 4, the storage capacity of the correction value memory 13 can be reduced to about half that of the conventional one as in the compression technique shown in FIG. 3.

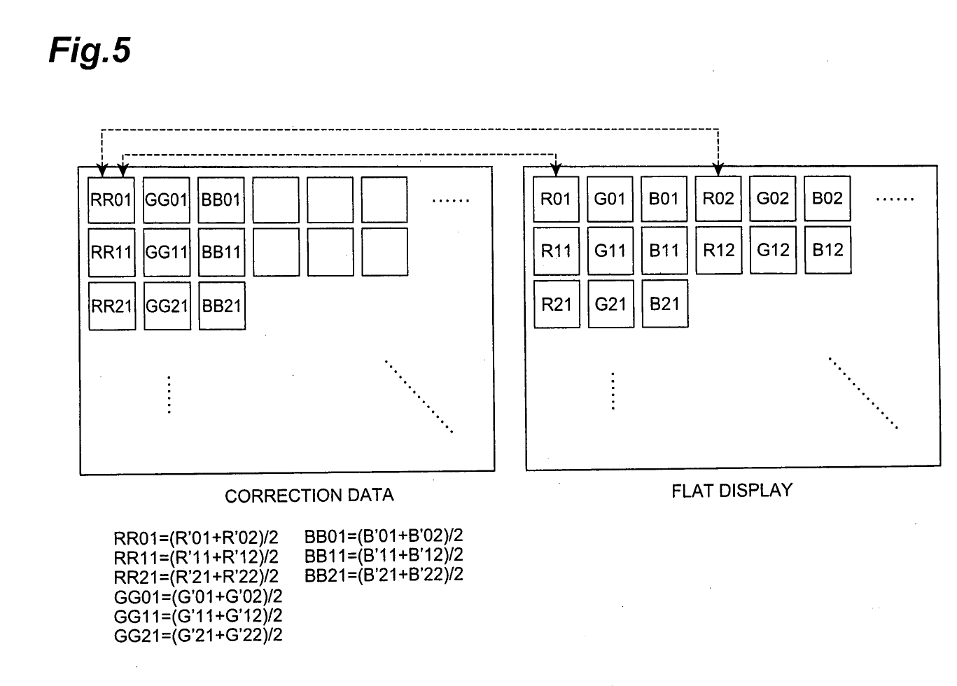

In the compression technique according to the fourth modification example shown in FIG. 5, one piece of correction data obtained from the correction data for the two display pixels is stored in the correction value memory 13 as the correction data for the two display pixels adjacent to each other in the horizontal direction in the flat display 18. For example, as the correction data for the adjacent two display pixels ji and ji+1, one piece of correction data RRji, GGji, or BBji is stored in the correction value memory 13 for each of the display colors of the light emitting elements. The correction data RRji, GGji, and BBji for the respective display colors of the light emitting elements are obtained here by calculating the average values of the correction data for the light emitting elements of the adjacent two display pixels ji and ji+1 as shown in the following mathematical expression (2). Only one piece of correction data is used for the two display pixels as described above, whereby the storage capacity of the correction value memory 13 can be reduced to about half that of the conventional one.

RRji=(R′ji+R′ji+1)/2

GGji=(G′ji+G′ji+1)/2

BBji=(B′ji+B′ji+1)/2 (2)

Note that while the correction data for the adjacent two light emitting elements are compressed to one piece of compressed correction data in the above-described compression techniques in FIG. 3 to FIG. 5, the correction data for the adjacent three or more light emitting elements may be compressed to one piece of compressed correction data in other embodiments. While the correction data for the light emitting elements adjacent to each other in the horizontal direction are compressed in the above-described compression techniques in FIG. 3 to FIG. 5, the compression data for the light emitting elements adjacent to each other in the vertical direction or the oblique direction may be compressed in other embodiments. Where the above-described compression techniques in FIG. 3 to FIG. 5 are employed, the decoder 14 only outputs the correction data taken in from the correction value memory 13 to the correction circuit 15 but does not perform processing of restoring the correction data.

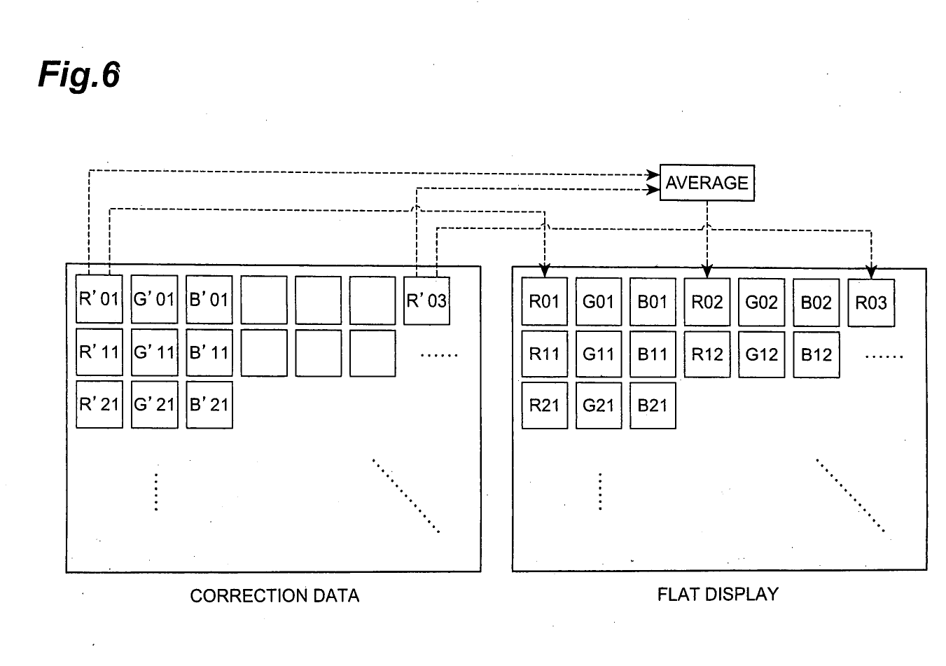

Next, the compression technique according to a fifth modification example will be described with reference to FIG. 6. In the compression technique shown in FIG. 6, the correction data R′ji, G′ji, and B′ji for a display pixel having an odd-numbered pixel position i in the horizontal direction are stored, but the correction data R′ji, G′ji, and B′ji for a display pixel having an even-numbered pixel position i in the horizontal direction are not stored. At the timing to output the correction data R′ji, G′ji, and B′ji for a display pixel having an odd-numbered pixel position i in the horizontal direction, the decoder 14 outputs the correction data R′ji, G′ji, and B′ji as they are. On the other hand, at the timing to output the correction data R′ji, G′ji, and B′ji for a display pixel having an even-numbered pixel position i in the horizontal direction, the decoder 14 calculates the correction data for a display pixel having an even-numbered pixel position i in the horizontal direction based on the correction data for a plurality of display pixels within a peripheral region and outputs the resulting correction data. To described in more detail, at the timing to output the correction data R′ji, G′ji, and B′ji for a display pixel having an even-numbered pixel position i in the horizontal direction, the decoder 14 calculates average values of correction data R′ji−1, G′ji−1, and B′ji−1, and R′ji+1, G′ji+1, and B′ji+1 for display pixels on both adjacent sides of that display pixel as shown in the following mathematical expression (3), and outputs the average values of the correction data instead of the missing correction data.

R′ji=(R′ji−1+R′ji+1)/2

G′ji=(G′ji−1+G′ji+1)/2

B′ji=(B′ji−1+B′ji+1)/2 (3)

Note that while the correction data for the light emitting elements adjacent to each other in the horizontal direction are averaged in the technique of restoring the missing correction data as described above, the correction data for the light emitting elements adjacent to each other in the vertical direction or the oblique direction may be averaged to calculate the correction data in other embodiments. Further, the technique of restoring the missing correction data as described above is also applicable to the case where a portion of the correction data is missing as a result of use of the technique of nonreversibly compressing the data such as the coding by JPEG format.

What is claimed is:

1. A picture display device for displaying a picture based on a picture signal, comprising:
correction data storage means for storing compressed data pertaining to correction data to correct luminance variations among display pixels; and
picture signal correction means for correcting the picture signal based on the compressed data stored in the correction data storage means to generate a picture signal in which the luminance variations among the display pixels are corrected.

2. The picture display device according to claim 1 further comprising:
picture display means for displaying a picture based on the picture signal in which the luminance variations among the display pixels are corrected.

3. The picture display device according to claim 1, further comprising:
decode means for restoring correction data before compression from the compressed data stored in the correction data storage means,
wherein the picture signal correction means corrects the picture signal using the correction data restored by the decode means.

4. The picture display device according to claim 1, wherein the compressed data stored in the correction data storage means is data in which a difference between the correction data for adjacent display pixels is compressed.

5. The picture display device
according to claim 1, wherein the compressed data stored in the correction data storage means is data in which the correction data is compressed for each display color.

6. The picture display device according to claim 1,
wherein the compressed data stored in the correction data storage means is data in which a portion of the correction data corresponds to a plurality of display pixels.

7. The picture display device according to claim 6,
wherein the portion of the correction data corresponding to the plurality of display pixels is a piece of correction data for the plurality of display pixels.

8. The picture display device according to claim 6,
wherein the portion of the correction data corresponding to the plurality of display pixels is an average value of the correction data for the plurality of display pixels.

9. The picture display device according to claim 3,
wherein the correction data storage means stores no correction data for a predetermined display pixel, and
wherein the decode means calculates the correction data for the predetermined display pixel based on correction data for a plurality of display pixels existing within a peripheral region of the display pixel.

10. A method for displaying a picture based on a picture signal and for storing compressed data of correction data for correcting luminance variations among display pixels, the method comprising:
correcting the picture signal based on the compressed data to generate a picture signal in which the luminance variations among the display pixels are corrected; and
displaying the picture based on the picture signal in which the luminance variations among the display pixels are corrected.

11. An apparatus comprising:
a memory to store compressed, correction data;
a decoder coupled to the memory, the decoder to restore correction data into an uncompressed state from the compressed correction data; and
a correction circuit coupled to the decoder, the correction circuit to correct a picture signal using the restored correction data recovered from the compressed correction data stored in the memory in order to correct luminance variations among display pixels of the picture signal.

12. The apparatus according to claim 11 further comprising:
a display to produce a picture based on the picture signal in which the luminance variations among the display pixels are corrected.

13. The apparatus according to claim 11, wherein the compressed correction data stored in the memory is data in which a difference between correction data for adjacent display pixels is compressed.

14. The apparatus according to claim 11, wherein the compressed correction data stored in the memory is data in which correction data is compressed for each display color.

15. The apparatus according to claim 11, wherein the compressed correction data stored in the memory is data in which a portion of the correction data corresponds to a plurality of display pixels.

16. The apparatus according to claim 15, wherein the portion of the correction data corresponding to the plurality of display pixels is an average value of the correction data for the plurality of display pixels.

17. The apparatus according to claim 11, wherein the decoder calculates the correction data for a predetermined display pixel based on correction data for a plurality of display pixels existing within a peripheral region of the predetermined display pixel.
